(19) United States
(12) Patent Application Publication
(10) Pub. No.: US 2022/0075064 A1
(43) Pub. Date: Mar. 10, 2022

(54) CAMERA SYSTEM WITH HIGH UPDATE RATE

(71) Applicant: ZF Friedrichshafen AG, Friedrichshafen (DE)

(72) Inventors: Christian SCHAALE, Weißensberg (DE); Steffen BUCHER, Friedrichshafen (DE)

(73) Assignee: ZF Friedrichshafen AG, Friedrichshafen (DE)

(21) Appl. No.: 17/414,485

(22) PCT Filed: Dec. 18, 2019
(86) PCT No.: PCT/EP2019/085887

§ 371 Date: Jun. 16, 2021

(30) Foreign Application Priority Data
Dec. 20, 2018 (DE) 10 2018 222 518.4

(51) Int. Cl. G01S 17/36; G01S 17/58; G01S 17/894; G01S 7/4865; H04N 5/232; G06T 7/20; G06T 7/579

(52) U.S. Cl. CPC G01S 17/36; G01S 17/58; G01S 17/894; G06T 2207/30268; H04N 5/23229; G06T 7/20; G06T 7/579; G01S 7/4865

(57) ABSTRACT

A device comprising a processor designed to execute a motion estimation based on intensity images (A_{Q}+B_{Q}, A_{I}+B_{I}) from a time-of-flight camera to generate motion vectors.

### TECHNICAL FIELD

The present invention relates to the field of camera systems, in particular time-of-flight camera systems.

### TECHNICAL BACKGROUND

Time-of-flight cameras are 3D camera systems that measure distances with a time-of-flight method (ToF method). A time-of-flight camera system uses an active pulsed light source for measuring the distance to objects in the field of vision. Pulsed light is transmitted with a fixed frequency.

An image sensor receives the reflected light. Its light-sensitive surface is forms a grid-like structure made up of small receptors forming “pixels.” When light strikes the light-sensitive surface, electron-hole pairs are generated. These charges are then stored in respective capacitors (charge stores). The charge of the capacitor after an exposure time (also referred to as an “input time”) elapses is output and is proportional to the light striking the respective pixel.

Based on this, the object of the invention is to improve a ToF camera.

This object is achieved by the device according to claim 1 and the method according to claim 10. Other advantageous embodiments of the invention can be derived from the dependent claims and the following description of preferred exemplary embodiments of the invention.

The exemplary embodiments illustrate a device comprising a processor configured to estimate motion based on intensity images from a time-of-flight camera (ToF camera) in order to generate motion vectors.

The device can be an image sensor, e.g. an image sensor in an indirect ToF camera (iToF camera). An indirect ToF camera (iToF camera) can measure the phase delays of reflected infrared light (IR light), for example. Phase data can be obtained by correlating the reflected signal with a reference signal (the lighting signal).

The processor is preferably configured to reconstruct a depth image on the basis of the phase images and the motion vectors while compensating for movement.

The intensity images and phase images from which distance information is obtained can be used, e.g., for tracking objects. Each of these intensity images and phase images can be used to increase the frame rate in comparison with normal operation.

The processor is preferably configured to determine a distance from two corresponding pixels in the phase data of the phase images when reconstructing the depth images while compensating for motion.

A pixel in a ToF camera typically comprises one or more light-sensitive elements (e.g. photo diodes). A light-sensitive element converts the incident light to a current. Switches (e.g. transfer gates) connected to the photo diodes can conduct the current to one or more storage elements (e.g. capacitors) that function as energy storage elements and accumulate and store charges.

The intensity images are preferably provided by a sensor in a time-of-flight camera, or are calculated by combining the raw images, if the sensor produces raw images.

According to one embodiment, the raw images comprise first raw images obtained with a modulation signal, and second raw images obtained with an inverted modulation signal. The first raw images can be provided, e.g., via a first pickup, Tap-A, of a time-of-flight pixel, and the second raw images can be obtained, e.g., via a second pickup, Tap-B, of the time-of-flight pixel, wherein the second pickup, Tap-B, obtains a reference signal that is inverted in relation to the first pickup, Tap-A, i.e. with a phase-shift of 180°. “Taps” refer to the locations in a time-of-flight pixel at which the photo-charges are acquired on the basis of a modulation signal. The modulation signal at Tap-A and the inverted modulation signal at Tap-B are also referred to as DMIX0 and DMIX1. In a so-called 2-tap/4-phase pixel, the modulator is an electro-optic 2-tap modulator. One advantage of the 2-tap/4-phase pixel is that all of the electrons generated by photons are exploited. Although the exemplary embodiments are based on 2-tap/4-phase pixels, other systems can also be used in alternative embodiments, e.g. 1-tap systems and systems with another number of phases.

The intensity images preferably comprise one or more first intensity images and one or more second intensity images, where the first intensity images and the second intensity images are determined in different modulation periods.

According to one exemplary embodiment, the processor is configured to generate a first depth image based on intensity images and phase images of a first modulation period and based on intensity images and phase images of a second modulation period, and to generate a second depth image based on intensity images and phase images of the second modulation period, and based on intensity images and phase images of a third modulation period. According to one exemplary embodiment, the first modulation period, second modulation period, and third modulation period are directly successive.

The depth images can be used to record the interior of a vehicle, in order to identify movements of people and objects in the interior.

The exemplary embodiments also disclose a method with which motion is estimated on the basis of intensity images from a time-of-flight camera to generate motion vectors, and which contains the aspects listed herein. The method can be implemented by a computer in a processor.

Embodiments are described merely by way of example, and in reference to the attached drawings. Therein:

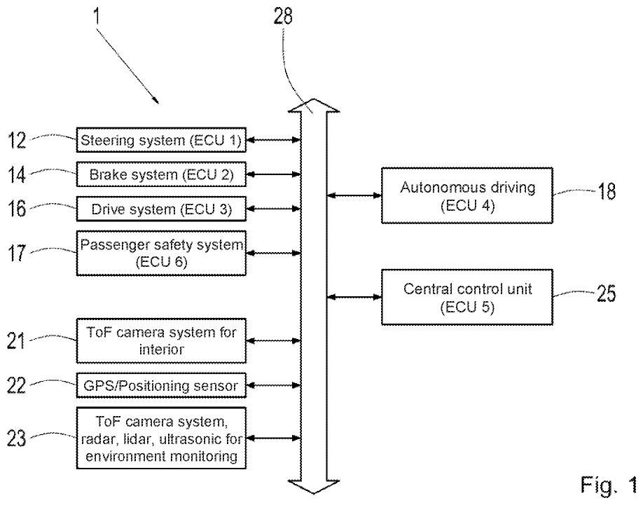

FIG. 1 shows a block diagram that schematically illustrates the configuration of a vehicle with a control unit for a passenger safety system and a time-of-flight camera system according to an exemplary embodiment of the present invention;

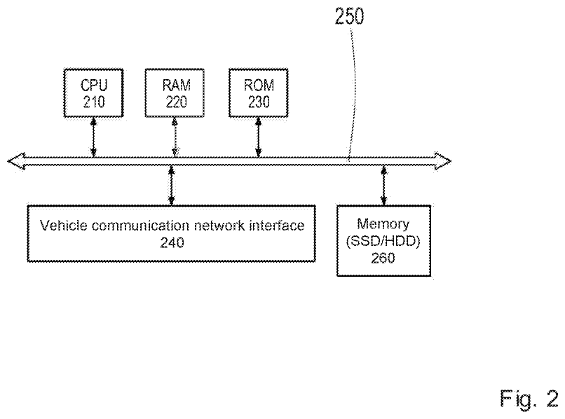

FIG. 2 shows a block diagram that illustrates an exemplary configuration of a control unit (ECU 1, 2, 3, 4, 5 and 6 in FIG. 1);

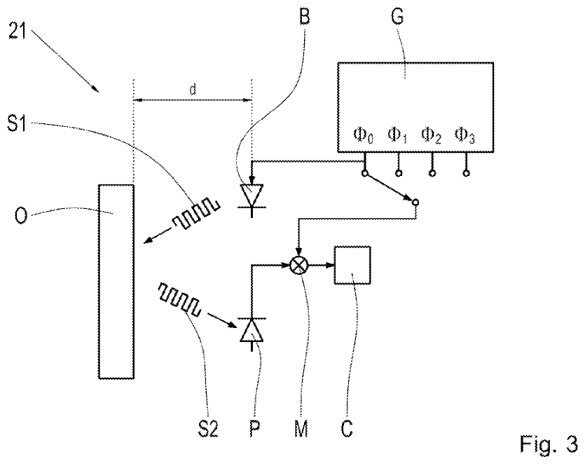

FIG. 3 shows a schematic illustration of a time-of-flight camera system (ToF camera system) 21;

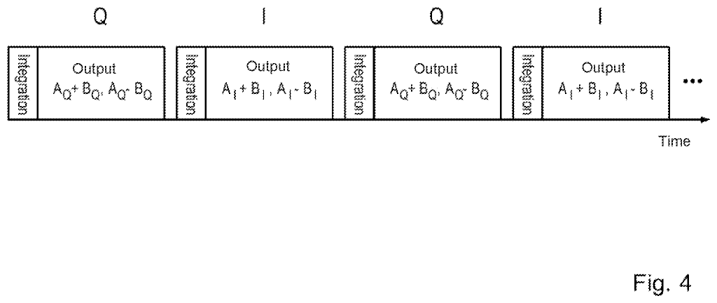

FIG. 4 shows a schematic illustration of the charge input and output process for the ToF camera system 21 shown in FIG. 3;

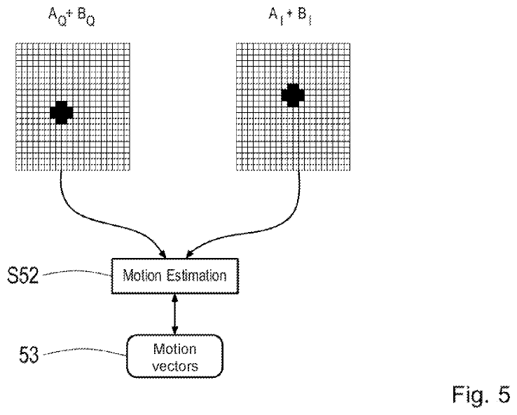

FIG. 5 shows an exemplary flow chart for determining motion vectors with the ToF camera system 21;

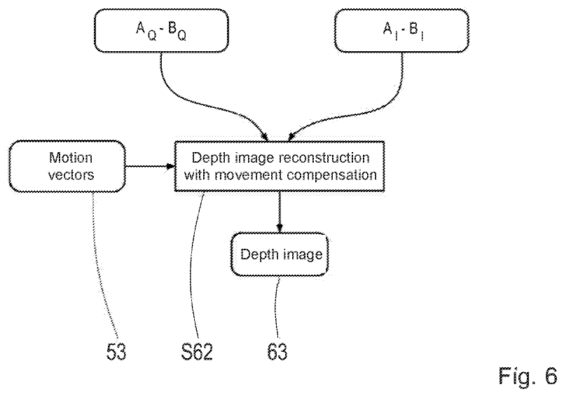

FIG. 6 shows a process for reconstructing a depth image while compensating for motion from two phase images; and

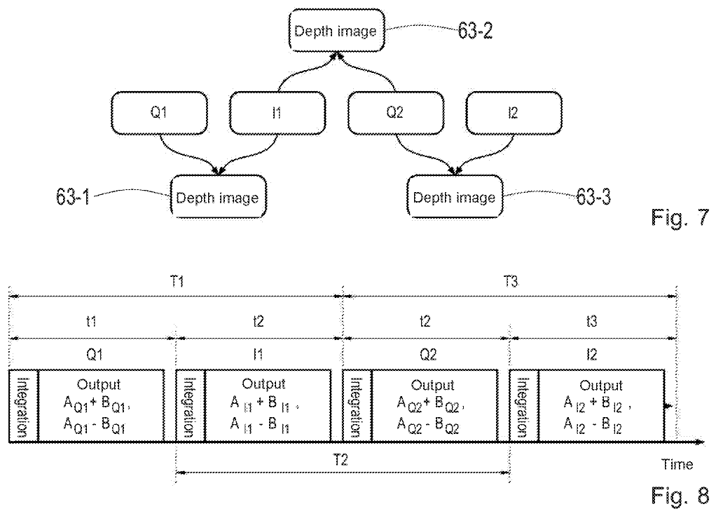

FIG. 7 shows a block diagram that illustrates a process with which a sequence of depth images of the vehicle interior are obtained, based on numerous respective exposure subframes;

FIG. 8 shows a schematic illustration of three modulation periods of the ToF camera system for obtaining depth images of the vehicle interior; and

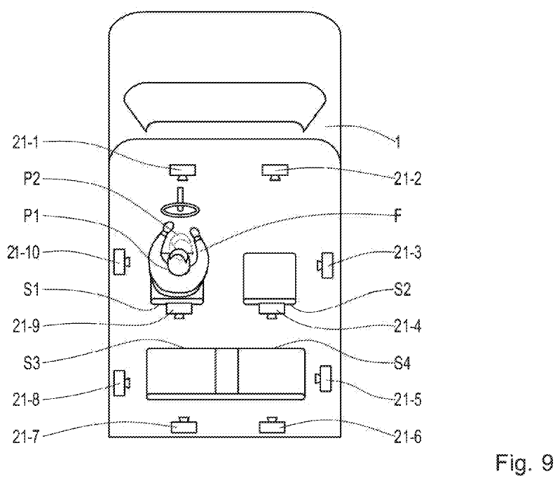

FIG. 9 shows a schematic illustration of a vehicle that has a ToF monitoring system for monitoring the vehicle interior.

FIG. 1 shows a block diagram that schematically illustrates the configuration of a vehicle that has a control unit for a passenger safety system and a time-of-flight camera system according to an exemplary embodiment of the present invention. The vehicle according to this exemplary embodiment is a vehicle that can maneuver in road traffic without, or in part without, the influence of a human driver. With autonomous driving, the control system for the vehicle assumes the role of the driver, entirely or substantially. Autonomous (or partially autonomous) vehicles can observe their environment with the help of various sensors, determine their position and identify other road users from the information that is obtained, and drive the vehicle to its destination with the help of the control system and the navigation software in the vehicle, and maneuver accordingly in road traffic.

The vehicle 1 comprises numerous electronic components that are connected to one another by a vehicle communication network 28. The vehicle communication network 28 can be a standard vehicle communication network installed in the vehicle, e.g. a CAN bus (controller area network), LIN bus (local interconnect network), ethernet-based LAN bus (local area network), MOST bus, LVDS bus, etc.

In the example shown in FIG. 1, the vehicle 1 comprises a control unit 12 (ECU 1), which controls the steering system. The steering system relates to components with which the vehicle is steered. The vehicle 1 also comprises a control unit 14 (ECU 2), which controls a braking system. The braking system relates to components that enable a braking of the vehicle. The vehicle 1 also comprises a control unit 16 (ECU 3), which controls a drive train. The drive train relates to the drive components for the vehicle. The drive train can comprise a motor, a transmission, a drive/propulsion shaft, a differential, and an axle drive.

The vehicle also comprises a control unit 17 (ECU 6), which controls a passenger safety system. The passenger safety system 17 relates to components that are intended to protect the driver in the case of an accident, e.g. an airbag.

The vehicle also comprises a control unit for autonomous (or partially autonomous) driving 18 (ECU 4). The control unit 18 for autonomous driving is configured to control the vehicle 1 such that it can maneuver in road traffic without, or partially without, the influence of a human driver. The control unit 18 for autonomous driving controls one or more vehicle subsystems while the vehicle 1 is operated in the autonomous mode, specifically the braking system 14, the steering system 12, the passenger safety system 17, and the drive system 14. For this, the control unit 18 for autonomous driving can communicate, e.g. via the vehicle communication system 28, with the corresponding control units 12, 14, 17, and 16.

The control units 12, 14, 17, and 16 can also receive vehicle operating parameters from the aforementioned vehicle subsystems, which determine these by means of one or more vehicle sensors. Vehicle sensors are preferably those sensors that detect a state of the vehicle or a state of vehicle parts, in particular their movement states. The sensors can comprise a vehicle speed sensor, a yaw sensor, an acceleration sensor, a steering wheel angle sensor, a vehicle load sensor, temperature sensors, pressure sensors, etc. By way of example, sensors can also be placed along the brake lines for outputting signals indicating the brake fluid pressure at various points along the hydraulic brake lines. Other sensors can be placed near the wheels which detect the speed of the wheels and the brake pressure applied to the wheels.

The vehicle 1 also comprises a GPS/positioning sensor unit 22. The GPS/positioning sensor unit 22 enables an absolute determination of the position of the autonomous vehicle 1 in relation to a geodata reference system (global coordinates). The positioning sensor can be a gyro-sensor, or the like, that reacts to accelerations, angular motion, or changes in position.

The vehicle 1 also comprises one or more sensor units 23 configured to monitor the environment. These other sensor units 23 can be a radar system, lidar system, ultrasonic sensors, ToF cameras, or other units. Data from distance and speed measurements are obtained with these other sensor units 23, and sent to the central control unit 25 (or the control unit 18 for autonomous driving, ECU 4). A distance between the vehicle 1 and one or more objects is determined on the basis of the data from these sensor units 23. The central control unit 25 can evaluate this information itself, or forward it to the control unit 18 for autonomous driving.

The vehicle 1 comprises a ToF camera system 21 in particular, that is designed to record three dimensional images of the vehicle interior. The ToF camera system 21 is located in the interior of the vehicle, as shown in greater detail in FIG. 6. The ToF camera system 21 records image data and transmits it to a central control unit 25 (or to the control unit 18 for autonomous driving, ECU 4). In addition to the image data, the ToF camera system 21 can also obtain metadata, e.g. position information, movement information, and/or distance information with respect to one or more objects in the imaging range and transmit it to the central control unit 25 (or to the control unit 18 for autonomous driving, ECU 4). The central control unit 25 can evaluate this information itself, or send it to the control unit 18 for autonomous driving.

In order to be able to react to different events, the interior of the vehicle is recorded based on the information from the ToF camera system 21. In the case of an accident, for example, the right airbags for where the passengers are sitting can be deployed.

If the operating mode for autonomous driving is activated by the control system or the driver, the control unit 18 for autonomous driving determines parameters for the autonomous operation of the vehicle (e.g. target speed, target torque, distance to a leading vehicle, distance to the edge of the roadway, steering procedures, etc.) based on the available data regarding a predefined route, based on the data received from the sensor unit 23, based on data recorded by the ToF camera system 21, and based on vehicle operating parameters recorded by the vehicle sensors, which are sent to the control unit 18 from the control units 12, 14, 17 and 16.

FIG. 2 shows a block diagram illustrating an exemplary configuration of a control unit (ECU 1, 2, 3, 4, 5, and 6 in FIG. 1). The control unit can be a control device (electronic control unit, ECU, or electronic control module ECM). The control unit comprises a processor 210. The processor 210 can be a computing unit, e.g. a central processing unit (CPU), that executes program instructions. The control unit also comprises a read-only memory, ROM 230, and a random access memory, RAM 220 (e.g. a dynamic RAM, “DRAM,” synchronous DRAM, “SDRAM,” etc.) in which programs and data are stored. The control unit also comprises a memory drive 260, e.g. a hard disk drive, HDD) a flash drive, or a non-volatile drive (solid state drive, SDD). The control unit also comprises a vehicle communication network interface 240, via which the control unit can communicate with the vehicle communication network (28 in FIG. 1). Each of the units in the control unit is connected via a communication network 250. In particular, the control unit in FIG. 2 can function as an implementation of the central control unit 25, ECU 5, in FIG. 1.

FIG. 3 shows a schematic illustration of a time-of-flight camera system 21 (ToF camera system). The ToF camera system 21 comprises a 4-phase signal generator G, a lighting unit B, a photosensor P for each pixel, a mixer M, and a charge store C for each pixel. The 4-phase signal generator g generates four modulation signals Φ₀, Φ₁, Φ₂, Φ₃, which are sent to the mixer M, wherein the modulation signal Φ₀ is sent to the lighting system B. The modulation signal Φ₀ is a rectangular function with a frequency of 10 to 100 MHz. The modulation signal Φ₁ is a signal that is phase-shifted 90° in relation to the modulation signal Φ₀. The modulation signal Φ₂ is a signal that is phase-shifted 180° in relation to the modulation signal Φ₀. The modulation signal Φ₃ is a signal that is phase-shifted 270° in relation to the modulation signal Φ₀. Based on the modulation signal Φ₀ generated by the 4-phase signal generator G, the lighting system B generates a light signal S1. The light signal S1 strikes an object O. A portion S2 of the light signal S1 is reflected back to the camera system. The reflected light signal S2 is received by a photosensor P for a pixel in the ToF camera system 21. The light signal S2 is demodulated with the respective modulation signal Φ₀, Φ₁, Φ₂, Φ₃ at the mixer M. The demodulation is based on the cross-correlation (integration) between the received light signal S2 and the respective modulation signal Φ₀, Φ₁, Φ₂, Φ₃. The demodulated signal is stored in a charge store C for the pixel. To determine the distance d between the object O and the ToF camera system 21, four images, corresponding to the four modulation signals Φ₀, Φ₁, Φ₂, Φ₃, are recorded within a modulation period.

FIG. 4 shows a schematic illustration of the charge input and output process for the ToF camera system 21 in FIG. 3, for obtaining intensity images and phase images of the vehicle interior. Time is plotted along the horizontal axis. Each of the exposure subframes Q, I comprises an input phase and a output phase. The exposure subframe Q and the exposure subframe I are repeated, wherein the exposure subframe Q and the exposure subframe I are offset 90°. The received light signal (S2 in FIG. 3) is integrated in the input phase with the respective modulation signal Φ₀, Φ₁, Φ₂, Φ₃, and the result of the input phase is output in pixels in the output phase.

The input process produces two raw images. A raw image A_{Q}=c(Φ₀) is obtained in the input phase of the exposure subframe Q, derived from the input of the received light and the modulation signal Φ₀, and a raw image B_{Q}=c(Φ₂) is obtained, derived from the input of the received light and the inverted modulation signal Φ₂. The raw image A_{Q} and the raw image B_{Q} are combined to obtain an intensity image A_{Q}+A_{B}, which serves as the basis for motion estimation (cf. FIG. 5 and the corresponding description). The raw image B_{Q} is also subtracted from the raw image A_{Q} to obtain a phase image A_{Q}−B_{Q}. The phase image A_{Q}−B_{Q} is used for generating a depth image (cf. FIG. 6 and the corresponding description). A raw image A_{I}=c(Φ₁) is obtained in the input phase of the exposure subframe I, derived from the input of the received light and the modulation signal Φ₁, and a raw image B_{I}=c(Φ₃) is obtained, derived from the input of the received light and the modulation signal Φ₃. The raw image A_{I} and the raw image B_{I} are combined to obtain an intensity image A_{I}+B_{I}, which serves as the basis for a motion estimation. The raw image B_{Q} is subtracted from the raw image A_{Q} to obtain a phase image A_{Q}−B_{Q}. This phase image A_{Q}−B_{Q} is used to generate a depth image.

FIG. 5 shows a process for estimating motion, which obtains motion vectors from successive intensity images A_{Q}+B_{Q} and A_{I}+B_{I}. The process for estimating motion can run, for example, in the central control unit (25 in FIG. 1) or in a processor for the ToF camera system (21 in FIG. 1). A motion estimation is carried out in step S52 based on the two intensity images A_{Q}+B_{Q} and A_{I}+B_{I}, to generate motion vectors 53. Motion estimation is the process of determining motion vectors that describe the transformation from one 2D image to another. The motion vectors 53 relate to the pixels in the images A_{Q}+B_{Q} and A_{I}+B_{I}, and represent the movement between the two images A_{Q}+B_{Q} and A_{I}+B_{I}. The motion vectors are obtained and depicted in a manner known to the person skilled in the art, e.g. through a translation model, e.g. pixel-recursive algorithms, methods for determining the optical flux, etc.

FIG. 6 shows a process for reconstructing a depth image with compensation for movement from two phase images A_{Q}−B_{Q} and A_{I}−B_{I}. A depth image 63 is reconstructed in step S62. The process for motion estimation can take place in the central control unit (25 in FIG. 1) or a processor for the ToF camera system (21 in FIG. 1). The depth image 63 is obtained on the basis of the phase image A_{Q}−B_{Q}, the phase image A_{I}−B_{I}, and the compensation for movement. The movement compensation is based on motion vectors 53, obtained with the process shown in FIG. 5 from the corresponding intensity images A_{Q}+B_{Q} and A_{I}+B_{I}.

The equation 1 shows how the distance d is obtained from two corresponding pixels (x, y), (x′, y′) (distance d between the moving reflecting object and the ToF camera system 21) from the phase information:

$$d = \frac{1}{2} \times ct = \frac{1}{4 π f} arctan \frac{{A}_{I}^{( {x}^{′} , {y}^{′} )} - {B}_{I}^{( {x}^{′} , {y}^{′} )}}{{A}_{Q}^{( x , y )} - {B}_{Q}^{( x , y )}} \qquad ( Eq . 1 )$$

Where f is the modulation frequency, c is the speed of light, t is the time of flight, and A_{I}^{(x′,y′)}, B_{I}^{(x′,y′)}, A_{Q}^{(x,y)}, B_{Q}^{(x,y)} are the respective phase data in the pixel P, and where the two corresponding pixels (x, y), (x′, y) are related to one another via a corresponding motion vector of the motion vectors (53).

Motion artifacts (“motion blur”) are reduced or compensated for by the above process (step S62) for reconstructing a depth image while compensating for movement. Motion blur normally occurs when objects move, or the ToF camera system 21 itself moves.

FIG. 7 shows a block diagram that illustrates the process in which a sequence of depth images of the vehicle interior is obtained, based on numerous respective exposure subframes. A first depth image 63-1 is obtained on the basis of a first exposure subframe Q1 and a first exposure subframe I1. A second depth image 63-2 is obtained on the basis of a first exposure subframe I1 and a second exposure subframe Q2. A third depth image 63-3 is obtained on the basis of a second exposure subframe Q2 and a second exposure subframe I2.

FIG. 8 shows a schematic illustration of three modulation periods in the ToF camera system 21 for obtaining depth images of the vehicle interior. As in FIG. 4, time is plotted on the horizontal axis. A depth image is obtained in the first modulation period T1 based on the intensity images A_{Q1}+B_{Q1} and A_{I1}+B_{I1} and phase images A_{Q1}−B_{Q1} and A_{I1}−B_{I1} obtained in the exposure subperiods t1 and t2, wherein the first exposure subperiod t1 relates to the exposure subframe A and the second exposure subperiod t2 relates to the exposure subframe I. A depth image is obtained in the second modulation period T2 based on the intensity images A_{Q2}+B_{Q2} and A_{I1}+B_{I1} and phase images A_{Q2}−B_{Q2} and A_{I1}−B_{I1} obtained in the exposure subperiods t2 and t3, wherein the first exposure subperiod t3 relates to the exposure subframe A1, and the second exposure subperiod t2 relates to the exposure subframe I. A depth image is obtained in the third modulation period T3 based on the intensity images A_{Q2}+B_{Q2} and A_{I2}+B_{I2} and phase images A_{Q2}−B_{Q2} and A_{I2}−B_{I2} obtained in the exposure subperiods t3 and t4, wherein the first exposure subperiod t3 relates to the exposure subframe Q2, and the second exposure subperiod t4 relates to the exposure subframe I2. Because a depth image is generated in each of the exposure subperiods t1, t2, t3, and t4, a high image update rate is obtained for the ToF camera system 21.

FIG. 9 shows a schematic illustration of a vehicle with a ToF monitoring system for monitoring the vehicle interior. The vehicle 1 has four seats S1 to S4, and ten ToF camera systems TF1 to TF10. The front seats S1 and S2 are for the driver F and a front-seat passenger, and the rear seats S3 and S4 are for passengers in the vehicle 1. A driver F sits in seat S1.

The ToF camera systems TF1 and TF2 are in the dashboard, ToF camera systems TF3, TF5, TF8, and TF10 are on the doors, ToF camera systems TF6 and TF7 are on the rear window shelf, and ToF camera systems TF4,TF9 are on the backs of the front seats S1, and S2.

FIG. 9 also illustrates, by way of example, the results of a rear-end collision with the vehicle 1, in which the driver's head moves from position P1 to position P2. The ToF camera systems TF1, TF2 and TF 10 record depth images of the vehicle interior, and send these depth images to a central control unit (25 in FIG. 1) in the vehicle 1. Based on these depth images, the central control unit determines the movement of the driver's head using image recognition algorithms known to the person skilled in the art. Based on the driver's head movement information, the central control unit can control the deployment of corresponding passenger safety systems (17 in FIG. 1), e.g. safety belt tensioners, airbags, etc.

It should be noted that the exemplary embodiments show methods with an exemplary sequence of the steps. The specific sequence of the steps is only indicated for illustrative purposes, and should not be regarded as binding.

The functionality described in this description can be implemented in the form of an integrated circuit logic, e.g. on a chip. The described functionality can also be implemented by software, if not otherwise indicated. If the embodiments described above are at least partially implemented with software-controlled processors, a computer program for such a software-based control and a corresponding storage medium are also regarded as aspects of the present disclosure.

### REFERENCE SYMBOLS

1 vehicle
12 steering system (ECU 1)
14 braking system (ECU 2)
16 drive system (ECU 3)
17 passenger safety system (ECU 6)
18 control unit for autonomous driving (ECU 4)
21 time-of-flight camera system
22 GPS/positioning sensor
23 sensor units
25 central control unit (ECU 5)
28 vehicle communication network
210 CPU
220 RAM
230 ROM
240 vehicle communication network interface
250 communication network
260 memory (SSD/HDD)
G 4-phase signal generator
B lighting system
E receiver
M mixer
P photosensor for a pixel
C charge memory C for the pixel
Φ₀, Φ₁, Φ₂, Φ₃ modulation signals
AQ+BQ, AI+BI intensity images
AQ−BQ, AI−BI phase images
AQ, BQ, AI, BI raw images
O object
d distance
S1 light signal
S2 reflected light signal
T modulation period
t1, t2 exposure subperiods
f modulation frequency
c speed of light

1. A device comprising:
a processor configured to execute a motion estimation based on intensity images (A_{Q}+B_{Q}, A_{I}+B_{I}) from a time-of-flight camera to generate motion vectors.

2. The device according to claim 1, wherein the processor is configured to reconstruct a depth image with compensation for movement based on phase images (A_{Q}−B_{Q}, A_{I}−B_{I}) and the motion vectors.

3. The device according to claim 2, wherein the processor is configured to obtain distance information (d) from two corresponding pixels ((x, y), (x′, y′)) from the phase data in the phase images (A_{Q}−B_{Q}, A_{I}−B_{I}).

4. The device according to claim 3, wherein the processor is configured to obtain the distance information (d) on the basis of the following equation:
$$d = \frac{1}{2} \times ct = \frac{1}{4 π f} arctan \frac{{A}_{I}^{( {x}^{′} , {y}^{′} )} - {B}_{I}^{( {x}^{′} , {y}^{′} )}}{{A}_{Q}^{( x , y )} - {B}_{Q}^{( x , y )}}$$
wherein ((x, y), (x′, y′)) are two corresponding pixels in the phase images (A_{Q}−B_{Q}, A_{I}−B_{I}), f is the modulation frequency, c is the speed of light, t is the time of flight, and A_{I}^{(x′,y′)}, B_{I}^{(x′,y′)}, A_{Q}^{(x,y)}, B_{Q}^{(x,y)} are the respective phase data in the pixel P, and where the two corresponding pixels (x, y), (x′, y′) are related to one another via a corresponding motion vector of the motion vectors.

5. The device according to claim 1, wherein the intensity images (A_{Q}+B_{Q}, A_{I}+B_{I}) are at least one of obtained from a sensor in a time-of-flight camera, or calculated by combining raw images (A_{Q}, B_{Q}, A₁, B_{I}).

6. The device according to claim 1, wherein the raw images (A_{Q}, B_{Q}, A_{I}, B_{I}) comprise first raw images (A_{Q}, A_{I}) obtained with modulation signals (Φ₀, Φ₁) and second raw images (B_{Q}, B_{I}) obtained with inverted modulation signals (Φ₂, Φ₃).

7. The device according to claim 1, wherein the intensity images (A_{Q}+B_{Q}, A_{I}+B_{I}) comprise one or more first intensity images (A_{Q}+B_{Q}) and second intensity images (A_{I}+B_{I}), wherein the first intensity images (A_{Q}+B_{Q}) and second intensity images (A_{I}+B_{I}) are obtained in different modulation periods.

8. The device according to claim 1, wherein the depth images are used to record the interior of a vehicle.

9. The device according to claim 1, wherein the processor is configured to generate a first depth image based on intensity images (A_{Q1}+B_{Q1}, A_{I1}+B_{I1}, A_{Q2}+B_{Q2}, A_{I2}+B_{I2}) and phase images (A_{Q1}−B_{Q1}, A_{I1}−B_{I1}, A_{Q2}−B_{Q2}, A_{I2}−B_{I2}) in a first modulation period and generate a second modulation period based on intensity images (A_{Q1}+B_{Q1}, A_{I1}+B_{I1}) and phase images (A_{Q1}−B_{Q1}, A_{I1}−B_{I1}), and to generate a second depth image based on intensity images (A_{Q2}+B_{Q2}, A_{I1}+B_{I1}) and phase images (A_{Q2}−B_{Q2}, A_{I1}−B_{I1}) in the second modulation period, and to generate a third modulation period based on intensity images (A_{Q2}+B_{Q2}, A_{I1}+B_{I1}) and phase images (A_{Q2}−B_{Q2}, A_{I1}−B_{I1}).

10. A method comprising:
estimating motion based on intensity images (A_{Q}+B_{Q}, A_{I}+B_{I}) from a time-of-flight camera to generate motion vectors.

11. The method according to claim 10, further comprising reconstructing a depth image with compensation for movement based on phase images (A_{Q}−B_{Q}, A_{I}−B_{I}) and the motion vectors.

12. The method according to claim 11, further comprising obtaining distance information (d) from two corresponding pixels ((x, y), (x′, y′)) from the phase data in the phase images (A_{Q}−B_{Q}, A_{I}−B_{I}).

13. The method according to claim 12, further comprising obtaining the distance information (d) on the basis of the following equation:
$$d = \frac{1}{2} \times ct = \frac{1}{4 π f} arctan \frac{{A}_{I}^{( {x}^{′} , {y}^{′} )} - {B}_{I}^{( {x}^{′} , {y}^{′} )}}{{A}_{Q}^{( x , y )} - {B}_{Q}^{( x , y )}}$$
wherein ((x, y), (x′, y′)) are two corresponding pixels in the phase images (A_{Q}−B_{Q}, A_{I}−B_{I}), f is the modulation frequency, c is the speed of light, t is the time of flight, and A_{I}^{(x′,y′)}, B_{I}^{(x′,y′)}, A_{Q}^{(x,y)}, B_{Q}^{(x,y)} are the respective phase data in the pixel P, and where the two corresponding pixels (x, y), (x′, y′) are related to one another via a corresponding motion vector of the motion vectors.

14. The method according to claim 10, wherein the intensity images (A_{Q}+B_{Q}, A_{I}+B_{I}) are at least one of obtained from a sensor in a time-of-flight camera, or calculated by combining raw images (A_{Q}, B_{Q}, A_{I}, B_{I}).

15. The method according to claim 10, wherein the raw images (A_{Q}, B_{Q}, A_{I}, B_{I}) comprise first raw images (A_{Q}, A_{I}) obtained with modulation signals (Φ₀, Φ₁) and second raw images (B_{Q}, B_{I}) obtained with inverted modulation signals (Φ₂, Φ₃).

16. The method according to claim 10, wherein the intensity images (A_{Q}+B_{Q}, A_{I}+B_{I}) comprise one or more first intensity images (A_{Q}+B_{Q}) and second intensity images (A_{I}+B_{I}), wherein the first intensity images (A_{Q}+B_{Q}) and second intensity images (A_{I}+B_{I}) are obtained in different modulation periods.

17. The method according to claim 10, wherein the depth images are used to record the interior of a vehicle.

18. The method according to claim 10, further comprising:
generating a first depth image based on intensity images (A_{Q1}+B_{Q1}, A_{I1}+B_{I1}, A_{Q2}+B_{Q2}, A_{I2}+B_{I2}) and phase images (A_{Q1}−B_{Q1}, A_{I1}−B_{I1}, A_{Q2}−B_{Q2}, A_{I2}−B_{I2}) in a first modulation period;
generating a second modulation period based on intensity images (A_{Q1}+B_{Q1}, A_{I1}+B_{I1}) and phase images (A_{Q1}−B_{Q1}, A_{I1}−B_{I1});
generating a second depth image based on intensity images (A_{Q2}+B_{Q2}, A_{I1}+B_{I1}) and phase images (A_{Q2}−B_{Q2}, A_{I1}−B_{I1}) in the second modulation period; and
generating a third modulation period based on intensity images (A_{Q2}+B_{Q2}, A_{I1}+B_{I1}) and phase images (A_{Q2}−B_{Q2}, A_{I1}−B_{I1}).
